(19) United States
(12) Patent Application Publication
(10) Pub. No.: US 2014/0259943 A1
(43) Pub. Date: Sep. 18, 2014

(54) Multi-Panel Door Assembly

(71) Applicant: ASI Doors, Inc., Milwaukee, WI (US)

(72) Inventor: George F. Balbach, Lake Bluff, IL (US)

(73) Assignee: ASI Doors, Inc., Milwaukee, WI (US)

(21) Appl. No.: 14/211,968

(22) Filed: Mar. 14, 2014

Related U.S. Application Data
(60) Provisional application No. 61/788,164, filed on Mar. 15, 2013.

(51) Int. Cl. E06B 3/46; E06B 7/28

(52) U.S. Cl. CPC E06B 3/4636; E06B 7/28
USPC 49/404; 49/506

(57) ABSTRACT

A door construction made of panel sections hinged to one another at end faces so as to be folded to overlie one another for transport and unfolded to a co-planar configuration at a point of assembly. After unfolding, braces are applied to the end faces to maintain the co-planar configuration. Gaskets are provided between facing surfaces of the two door sections, and a gasket may be provided around the perimeter of the door and the gaskets span the seam. A wire may also be provided that spans the seam and remains intact before, during, and after unfolding.

### CROSS-REFERENCE TO RELATED APPLICATIONS

This claims the benefit of U.S. Provisional Patent Application No. 61/788,164 filed Mar. 15, 2013, the full disclosure of which is hereby incorporated for all purposes.

### STATEMENT CONCERNING FEDERALLY SPONSORED RESEARCH OR DEVELOPMENT

Not applicable.

### FIELD OF THE INVENTION

This invention relates to doors, and in particular to large industrial sliding doors and particularly refrigerated storage room doors that have gaskets or a heat wire around the perimeter of the door.

### BACKGROUND OF THE INVENTION

Sliding doors, particularly powered sliding doors, are often used in refrigerated or frozen storage rooms of warehouses. The doors are large because in many cases they must accommodate the passage of material handling equipment. Getting these doors from the manufacturing plant to the end user can be problematic using customary shipping channels when the size exceeds a certain limit. Many times, that limit is nine feet wide by nine feet high. This invention addresses that issue.

### SUMMARY OF THE INVENTION

The invention provides a door panel that is split so as to have a seam, and wherein the panels of the door are hinged during shipping to reduce the footprint of the door. Once received at the point of installation, the installers unpack the door, unfold it, remove the shipping hinges and replace them with splice plates that hold the panels of the door in a plane. Thereby, the shipping dimensions of the door are reduced to within acceptable limits without causing undue installation burdens.

Preferably, the split in the door is horizontal. For horizontal sliding doors, the horizontal split is most readily accommodated.

In a preferred aspect, gaskets are provided at the seam so that when the door panels are put together, the gaskets seal the interface at the edges of the two or more panels.

In another preferred aspect, the door preferably includes gaskets on its inner side that can deform when the door is folded about the hinge axis for shipping. This permits the gasket to span the gap at the seam between the two panels. In addition, a heating wire may also span the gap and be provided around a portion of the perimeter of the door or the entire door. The invention permits the gasket and the wire to remain intact during assembly and unfolding of the door.

After the door is unfolded, as stated above, braces are installed to maintain the door panels in a planar configuration. In addition, if gaskets are provided on a face of the door, a gasket retainer splice may be secured to the door so as to retain the gaskets where they span the seam between the door panels. The hinges and braces are preferably installed against the opposite end surfaces of the door panels, at the sides of the door.

The invention, in one aspect, provides a door panel kit in which a door panel has at least two panel sections that are hinged to fold 180° between a planar configuration in which edges of the panel sections are in facing relationship at a seam to being in a folded configuration in which they overlie one another in parallel planes with the seam open. The door is typically shipped with the panel sections in the folded configuration connected by the hinge so as to reduce the largest shipping dimensions of the door. At the assembly location, the door is unfolded to be placed in the planar configuration and is secured in that configuration by installing panel splice plates to brace and maintain it in the planar configuration. The door panel can then be handled and hung in the door application for which is it intended.

Various other aspects are also disclosed by the invention. For example, the hinges can be removed after transport. In addition, the door can have gaskets and/or a heating wire that spans the seam between the two panel sections on one or both sides of the door. A gasket retainer may be installed under the part of the gasket that spans the seam to retain the gasket in that area. In addition, the edges of the door that meet in face-to-face relationship at the seam can have gaskets provided on them so that they seal against one another at the seam. In addition, the seam can be caulked either before or after the panel sections are placed in the planar configuration.

In another preferred aspect, the hinges can be removed before installing the braces and the braces can use the same holes as the hinges. The hinges can include a slotted hinge plate that receives the hinge pin to provide for some variability in installation, with the hinge axis offset to the side of the plane in which the door rests in the planar configuration. Also, preferably, the hinge plates are secured to the side edges of the door, on the end surfaces of the door. The plates are screwed against the end surfaces with one plate having a slotted section that overlies the other plate and a screw is put through the slot into the other plate to act as the hinge pin.

In another aspect, the seam is horizontal which is especially preferred for a horizontal sliding door panel that has mainly back-and-forth forces imparted to it. In other words, the seam is parallel to the top and bottom edges of the door. Preferably, to minimize the shipping dimensions, the seam is midway between the top and bottom edges of the door so as to split the door in half. In that configuration, the door panel is made of two panel sections of approximately the same size.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a prior art sliding industrial door of the type to which the invention may be applied;

FIG. 2A is a perspective view of a door panel of the invention shown in a folded configuration with panel sections of the door panel adjacent in generally parallel planes;

FIG. 2B is a detail view of the hinge connection at one end of the door panel of FIG. 2A;

FIG. 3A is a view illustrating the door panel of FIG. 2A laid flat in the folded configuration prepared to be unfolded;

FIG. 3B is a detail view of the hinge at one side of the door panel of FIG. 3A;

FIG. 4A is a perspective view of the door panel of FIG. 3A unfolded in a planar configuration and shown with the hinges at opposite sides exploded;

FIG. 4B is a detail view of the hinges at one side exploded;

FIG. 5A is a view like FIG. 4A but showing a splice plate or brace exploded off from each side of the door panel;

FIG. 5B is a detail view of a splice plate exploded off from the left side of the door panel in FIG. 5A;

FIG. 6A is a view like FIG. 5A but showing the splice plates assembled to both sides of the door panel and showing a gasket retainer exploded from each side of the door panel;

FIG. 6B is a detail view of the gasket retainer exploded off from the left side of the door panel of FIG. 6A;

FIG. 7 is an end plan view showing the gasket retainer exploded off from the door panel;

FIG. 8 is an end plan view like FIG. 7 but showing the gasket retainer assembled to the door panel; and

FIG. 9 is a perspective view of the assembled door panel.

### DETAILED DESCRIPTION OF THE PREFERRED EMBODIMENTS

FIG. 1 shows prior art door 10 that includes a door panel 12 and other hardware pieces necessary for its use and installation such as a handle 14. The door 10 is hung from trucks 16 that roll on a track 18 so that the door 10 can be slid horizontally side to side over an opening or not over an opening to close and open it. Typically, the door 10, on its side facing the wall 20 in which the opening is provided has gaskets around at least its two sides and the top of the door and another gasket against the bottom edge of the door so that the door is sealed on all four sides. There typically is a temperature difference on opposite sides of the wall 20 so the gaskets are important to maintain a seal to conserve energy. In addition, as the gasketed side of the door, or inside side of the door, may be a refrigerated space, a heater wire may extend around the perimeter of the door in the area of the gaskets so as to help defrost the gaskets. As typical shipping limits usually have a maximum shipping dimension, for example nine feet wide by nine feet high, when the door 10 was made larger than that, special shipping accommodations had to be made.

FIGS. 2 through 9 illustrate a door 30 of the invention. The door 30 includes a door panel 32 having two panel sections 34 and 36. The door panel 32 is split in the middle along a horizontal seam, i.e. parallel to the upper and lower edges of the door panel so that the two panel sections 34 and 36 are approximately equal in size. Gaskets 40 are provided around the perimeter of the top edge 42 of panel section 34 and around the bottom edge 44 of panel section 36 so that when the panel sections 34 and 36 are unfolded into a planar configuration as illustrated in FIG. 4A, the two edges 42 and 44 meet in facing arrangement to create a horizontal seam in the door panel 32 with the gaskets 40 abutting and sealing the seam.

The door panel 32 on the end faces of the panel at opposite ends adjacent to the seam has a hinge 50 at each end that helps maintain the folded configuration during shipping of the door 30 and facilitates unfolding of the door 30 to the parallel configuration. After folding and in preparation for shipping, the door sections are kept folded with packaging, such as being put into a box or other container, or being banded by wrapping and retaining one or more bands like band 41 (shown in phantom in FIG. 2A) around them or the container they're in.

Referring particularly to FIGS. 3A-4B, the hinge 50 includes a slotted hinge plate 52 which has a dog-legged slotted extension 54 bent upwardly out of the plane of the remainder of the plate 52 so as to lie above base hinge plate 56. Both hinge plates 52 and 56 are secured to the end faces of the respective panel sections 34 and 36 adjacent to the respective edges 42 and 44 by screws 58, with shims 66 and 68 between the hinge plates and the end face. A screw 60 that extends through the slot of the extension 54 is screwed into base plate 56 and forms a hinge pin to define a hinge axis that is generally parallel to the edges 42 and 44 and between them. The slot permits the two panel sections 34 and 36 to lay flat against one another when in the folded configuration and permits the two panel sections 34 and 36 to be adjusted when unfolded in the direction indicated by arrow 62 so that the two panel sections 34 and 36 lay in a common plane in the planar configuration of FIG. 4A, with the gasketed or inner side 64 of the door 30 facing up. As viewed in FIG. 4B, shims or spacers 66 and 68 are provided between the respective plates 52 and 56 to provide overlapping relationship between the hinge plates. The gasket 72 extends around the sides and top of the door and a bottom seal gasket 74 extends between the lower edge of the door and the floor when the door is installed. The gasket 72 may extend around the three sides continuously (i.e. in one piece), or it may be broken or split at the seam. In either event, the gasket 72 spans the seam and together with gasket 74 seals the door around its entire perimeter.

When the door 30 is unfolded to its planar configuration as shown in FIGS. 4A-6B, the hinges 50 are removed and braces, in the form of splice plates 70, are installed against the end surfaces where the hinges formerly were and spanning the seam so as to secure the door panel 32 in its planar configuration. Suitable fasteners are used as are the holes in the end faces of the panels that were used to secure the hinge 50. Once secured, the splice plate 70 holds the door panel 32 in the planar configuration with the gaskets 40 sealing the seam 25.

Where the gasket 72 crosses the seam 25 along opposite side edges of the door 30 (referring to FIGS. 6A-8) on the front or rear face of the door, a gasket retainer 80 is secured to the panels 34 and 36 using suitable fasteners 82 to secure the gaskets 72 where it spans the seam 25. The retainer 80 is like similar retainer pieces that retain the gasket 72 around the remainder of the perimeter on the three sides that the gasket 72 is assembled except it is made to be assembled under the gasket rather than from the end of the gasket. A gap 84 is presented between the ends of the retainer 86 that is assembled on the panels 34 and 36 at the factory and is already present before the door is unfolded. As illustrated in FIGS. 7 and 8, a splice plate 88 is installed over the gasket retainer 80 to secure the bulbous ends of the gasket fins that make up the gasket 72 in the corners of the retainer 80. As illustrated, the retainer 80 is an open channel which is partially closed by the splice plate 88. As previously described, this splice can be applied whether the gasket 72 is split at the seam 25 or whether it continues in one piece over the seam 25.

In addition to the gasket 76 that spans the seam, the door may also have a wire 90 illustrated in FIGS. 7 and 8 that spans the seam. The wire 90 may be provided for any of a variety of purposes such as power, or communications, but in the application illustrated, it is a resistance heater wire that is energized at times for keeping the edges and gaskets relatively free of frost. The wire 70 remains intact spanning the seam 25 during folding and unfolding of the door panel sections, as does the gasket 72. Preferably, the wire 90 is closer to the interior surface of the door since that is the side that is closer to the hinge axis so as to minimize the length of the path the wire has to take from one panel section to the other in the folded configuration.

FIG. 9 illustrates the unfolded door 30 in the planar configuration. Preferably, the seam 25 is caulked after it is unfolded and secured in the planar configuration. The door 30 is now ready to be hung, for example as a horizontal sliding door as illustrated in FIG. 1.

Therefore, in addition to the above description, the procedure for shipping and assembling a panel of the invention is that the panels are hinged for transport and need to be unfolded and assembled before installation in the final location that they will be used. When received at the location of installation, the installer unpackages the door and lays the folded door flat with the lower half facing down on a horizontal surface as shown in FIG. 3A, with the slotted hinge plate pointing up. The panel is supported with wood or Styrofoam blocks or other suitable means to prevent damage to the panel surface and exterior hardware. The door is then unfolded so both the upper half and the lower half are in the planar configuration with the front or outer side of the door down and the rear or inner side of the door panels provided with the gaskets facing up as illustrated in FIG. 4A. The shipping hinges and shims are then unbolted from both sides of the door panels and may be discarded. The splice plates 70 are then assembled to both sides of the door panels spanning the seam 25. The panel sections may need to be compressed together slightly when attaching the splice plates so as to seal the gaskets 40 between the panel sections 34 and 36. The two gasket splice plates 80 on the inner side of the door that support the gasket as it spans the seam are then assembled on both sides of the door into the gap between the existing gasket retainers 86 and with the beads of the gaskets fitting in the inside profile of the gasket retainer splice plate. The panel splice plate 88 is then assembled and centered on the gasket retainer splice plate 80 to hold the bead of the two fm gaskets that make up the gasket 72 in position. This is done on both the left and right sides of the door.

Thereby the invention provides a method of making, shipping, and assembling a door, as well as a door structure and a kit for making a door.

A preferred embodiment of the invention has been described in considerable detail. Many modifications and variations to the preferred embodiment described will be apparent to a person of ordinary skill in the art. Therefore, the invention should not be limited to the embodiment described.

I claim:

1. A method of shipping and assembling a door, comprising the steps of:
hinging two panel sections to fold 180° between a folded configuration in which the two panel sections overlie one another and a planar configuration in which the two panel sections are unfolded edge to edge at a seam and substantially co-planar with one another;
packaging the door panel sections in the folded configuration;
transporting the panel sections in the folded configuration to an assembly location;
unfolding the door panel sections at the assembly location so as to place the panel sections in the planar configuration; and
installing braces to the door panel sections so as to secure the panel sections in the planar configuration.

2. A method as claimed in claim 1, further comprising the step of removing the hinges after transporting the door.

3. A method as claimed in claim 1, wherein the door has a gasket on at least one side that spans the seam.

4. A method as claimed in claim 1, wherein the door has a wire that spans the seam.

5. A method as claimed in claim 1, wherein a gasket retainer splice is installed after unfolding the panel sections to retain a gasket in an area that spans the seam.

6. A method as claimed in claim 1, wherein the edges of the panel sections that meet at the seam have gaskets that seal the seam.

7. A method as claimed in claim 1, wherein the seam is caulked in the planar configuration.

8. A method as claimed in claim 1, wherein the braces are installed to the door sections using at least some of the same holes as the hinges.

9. A method as claimed in claim 1, wherein each hinge includes at least one slotted hinge plate installed on an end face of a panel.

10. A method as claimed in claim 1, wherein the seam is generally parallel to upper and lower edges of the door in the planar configuration.

11. A method as claimed in claim 1, wherein the seam is horizontal.

12. A method as claimed in claim 1, wherein the seam is approximately midway between top and bottom edges of the door in the planar configuration.

13. A method as claimed in claim 1, wherein the hinges and braces are installed against end surfaces of the door panel sections.

14. A kit for making a door, comprising:
door panel sections hinged together and folded to overlie one another in a folded configuration;
packaging maintaining the door panel sections in the folded configuration; and
braces adapted to be secured to the panel sections so as to maintain the panel sections in a planar configuration when the sections are unfolded.

15. A kit as claimed in claim 14, further comprising gaskets on at least one side of the door in the planar configuration, which gaskets remain on the door when the door is folded into the folded configuration in which the sections overlie one another.

16. A kit as claimed in claim 14, wherein there is a gasket between the facing surfaces of the panel sections at a seam created by the facing surfaces when the panel sections are unfolded into the planar configuration.

17. A door construction comprising:
at least two door sections previously hinged together to overlie one another; and
braces holding the door sections in a co-planar configuration with a seam between facing surfaces of the sections.

18. A door construction as claimed in claim 17, comprising:
gaskets on an inside surface of the door that were intact prior to the two door sections being unfolded and that span the seam in the co-planar configuration.

19. A door construction as claimed in claim 18, further comprising a heater wire that spans the seam.

20. A door construction as claimed in claim 17, wherein gaskets are provided between facing surfaces of the two door sections at the seam.
